(19) United States
(12) Patent Application Publication
(10) Pub. No.: US 2010/0023203 A1
(43) Pub. Date: Jan. 28, 2010

(54) DIAGNOSIS SYSTEM AND METHOD FOR ASSISTING A USER

(76) Inventor: Oren Shibi, Ramat HaSharon (IL)

Correspondence Address: CANTOR COLBURN, LLP, 20 Church Street, 22nd Floor, Hartford, CT, 06103, US

(21) Appl. No.: 12/508,019

(22) Filed: Jul. 23, 2009

Related U.S. Application Data
(60) Provisional application No. 61/082,837, filed on Jul. 23, 2008.

(51) Int. Cl. G06F 7/00

(52) U.S. Cl. 701/33

(57) ABSTRACT

A system and method for facilitating a user in diagnosing a vehicle is provided. The method comprises receiving a signal from the vehicle utilizing a diagnostic manager module, the signal having diagnostic data configured to identify one or more faults in the vehicle; processing the signal to select a set of predetermined instructions that assists the user in correcting the one or more faults; accessing the set of predetermined instructions from a database; and communicating the set of predetermined instructions interactively with the user in a step-by-step manner through a series of visuals.

### CROSS-REFERENCE TO RELATED APPLICATIONS

This application claims the benefit of U.S. Provisional Patent Application Ser. No. 61/082,837, filed on Jul. 23, 2008, the contents of which are incorporated herein by reference thereto.

### BACKGROUND OF THE INVENTION

The Environmental Protection Agency (EPA) requires vehicle manufacturers to install on-board diagnostics (OBD-II) for monitoring light-duty automobiles and trucks beginning with model year 1996. OBD-II systems (e.g., microcontrollers and sensors) monitor the vehicle's electrical and mechanical systems and generate data that are processed by a vehicle's engine control unit (ECU) to detect any malfunction or deterioration in the vehicle's performance. Most ECUs transmit status and diagnostic information over a shared, standardized electronic buss in the vehicle. The buss effectively functions as an on-board computer network with many processors, each of which transmits and receives data. The primary computers in this network are the vehicle's electronic-control module (ECM) and power-control module (PCM). The ECM typically monitors engine functions (e.g., the cruise-control module, spark controller, exhaust/gas recirculator), while the PCM monitors the vehicle's power train (e.g., its engine, transmission, and braking systems): Data available from the ECM and PCM include vehicle speed, fuel level, engine temperature, and intake manifold pressure. In addition, in response to input data, the ECU also generates 5-digit diagnostic trouble codes (DTCs) that indicate a specific problem with the vehicle. The presence of a DTC in the memory of a vehicle's ECU typically results in the illumination of the Service Engine Soon or Check Engine light present on the dashboard of most vehicles.

Data from the above-mentioned systems are made available through a standardized, serial 16-cavity connector referred to herein as an ‘OBD-II connector’. The OBD-II connector typically lies underneath the vehicle's dashboard. When a vehicle is serviced, data from the vehicle's ECM and/or PCM is typically queried using an external engine-diagnostic tool (commonly called a ‘scan tool’) that plugs into the OBD-II connector. The vehicle's engine is turned on and data are transferred from the engine computer, through the OBD-II connector, and to the scan tool. The data are then displayed and analyzed to service the vehicle. Scan tools are typically only used to diagnose stationary vehicles or vehicles running on a dynamometer.

The car industry has evolved in recent years in a way that most vehicle components are either electronic or electronically controlled. This phenomenon is expected to increase in the future. Repairing faults in those new vehicle components has become difficult to nearly impossible without external guidance.

Current solutions include searching for manufacturer manuals that help technicians in troubleshooting and repairing the vehicle faults, which can be time consuming and costly. Current systems provide tedious textual and flowchart materials on printed paper or computerized PDF forms to help technicians troubleshoot and repair vehicle faults. Reviewing these textual materials can be time consuming and costly. Technicians have also used trial and error in troubleshooting and repairing vehicle faults. However, this can also be costly for the clients due to the amount of time spent on narrowing down the source of the problem and finding a solution to the same.

### SUMMARY OF THE INVENTION

These and other advantages and features will become more apparent from the following description taken in conjunction with the drawings.

In one exemplary embodiment, a method for facilitating a user in diagnosing a vehicle is provided. The method includes receiving a signal from the vehicle utilizing a diagnostic manager module, the signal having diagnostic data configured to identify one or more faults in the vehicle; processing the signal to select a set of predetermined instructions that assists the user in correcting the one or more faults; accessing the set of predetermined instructions from a database; and communicating the set of predetermined instructions interactively with the user in a step-by-step manner through a series of visuals.

In another exemplary embodiment, a diagnostic system for facilitating a user in diagnosing a system is provided. The diagnostic system includes a processor configured to receive a signal from the system, the signal having diagnostic data configured to identify one or more faults in the vehicle, an application server in communication with the processor via a network, the processor configured to process the signal and receive a set of predetermined instructions from the application server, the set of predetermined instructions configured to assist the user in correcting the one or more faults; and a display device coupled to the processor, the display device configured to communicate the set of predetermined instructions interactively with the user in a step-by-step manner through a series of visuals.

In yet another exemplary embodiment, a method for facilitating a user in diagnosing and repairing a system is provided. The method includes receiving a signal from the system utilizing a diagnostic manager module, the signal having diagnostic data configured to identify one or more faults in the system; processing the signal to obtain a set of predetermined instructions that assists the user in correcting the one or more faults; and communicating the set of predetermined instructions interactively with the user in a step-by-step manner through a series of visuals.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustrating a diagnostic system having multiple computing devices communicatively coupled to a server via a network in accordance with one exemplary embodiment of the present invention;

FIG. 2 is a schematic illustrating the diagnostic system with one computing device coupled to the server via the network in accordance with one exemplary embodiment of the present invention;

FIG. 3 is a schematic illustrating a computing device of the diagnostic system coupled to a vehicle to be diagnosed in accordance with one exemplary embodiment of the present invention;

FIG. 4 is an exemplary screen shot of an exemplary visual used to assist a user in diagnosing the vehicle in accordance with one exemplary embodiment of the present invention;

FIG. 5 is another exemplary screen shot of another exemplary visual used to assist the user in diagnosing the vehicle in accordance with one exemplary embodiment of the present invention; and

FIG. 6 is a flow diagram of a method for facilitating the user in diagnosing the vehicle in accordance with one exemplary embodiment of the present invention.

### DETAILED DESCRIPTION

Exemplary embodiments of a diagnostic system and a method for facilitating a user in diagnosing a system (e.g., vehicle) in accordance with the present invention will now be described with reference to the drawings. Exemplary embodiments of a diagnostic system described herein are configured to receive a signal from a system utilizing a diagnostic manager module where the signal includes diagnostic data configured to identify one or more faults in the system. The exemplary embodiments of a diagnostic system described herein are further configured to process the signal to select a set of predetermined instructions that assists the user in correcting the one or more faults. The exemplary embodiments of a diagnostic system described herein are further configured to access the set of predetermined instructions from a database and communicate the set of predetermined instructions interactively with the user in a step-by-step manner through a series of visuals.

As used herein, the term “module” refers to an application specific integrated circuit (ASIC), an electronic circuit, a processor (shared, dedicated, or group) and memory that executes one or more software or firmware programs, a combinational logic circuit, and/or other suitable components that provide the described functionality.

In accordance with one exemplary embodiment, a computing device is selectively coupled to a control unit of a system via an OBDII connector or a diagnostic socket/interface of the system in order to receive and analyze system operational information, such as, for example, diagnostic faults, from the control unit of the system. The control unit transmits status and diagnostic information over a CAN BUS protocol in accordance with one exemplary embodiment. Of course, the control unit can transmit system information over any standard vehicle protocol or electronic buss in accordance with other exemplary embodiments.

In accordance with one exemplary embodiment, the computing device processes the system information from the control unit to select a set of predetermined instructions that assists the user in correcting the one or more diagnostic faults. The computing device accesses the set of predetermined instructions from a database (offline) in accordance with one embodiment. In an alternative embodiment, the set of predetermined instructions can be accessed from an application server via a network. In one embodiment, the computing device sends repair orders to the control unit enabling the control unit to automatically correct one or more electronic faults. The computing device then verifies the correction in accordance with one embodiment. The computing device communicates the set of predetermined instructions interactively with a user (e.g., system technician) in a step-by-step manner through a series of visuals. Optionally, the computing device communicates the set of predetermined instructions to the user by generating a plurality of audio signals.

In accordance with one exemplary embodiment, the application server is communicatively coupled with a statistics and machine learning server configured to automatically find and propose optimizations for the process(s) in correcting the one or more faults utilizing a neural network module, which can be any conventional artificial intelligent network software application that uses one or more Bayesian network equations and/or algorithms that are based generally on the concept of self-learning.

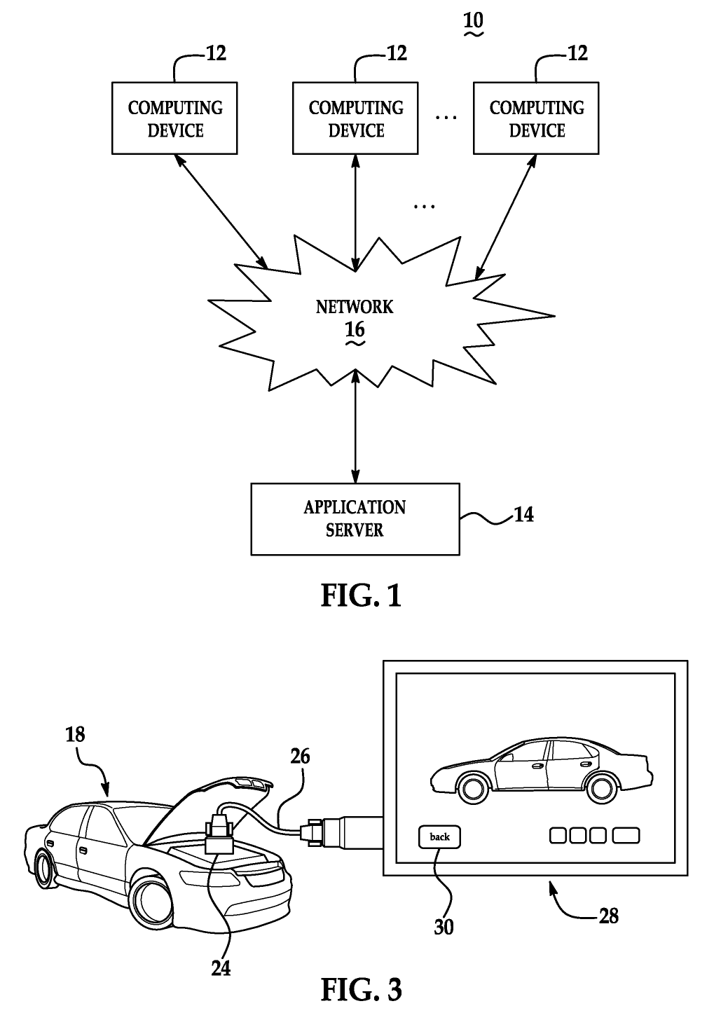

Turning now to the drawings in greater detail, FIG. 1 illustrates a diagnostic system 10 implemented in a client-server configuration in accordance with one non-limiting exemplary embodiment. The diagnostic system 10 comprises one or more computing devices 12 that are each communicatively coupled to an application server 14 via a network 16 and communicatively coupled to one another via the network 16. For ease of discussion, only one computing device will be discussed in greater detail below. It should be understood that although the diagnostic system 10 shown in FIG. 1 is implemented in a client-server configuration other implementations are contemplated. As can be appreciated, the diagnostic system can be implemented as a single computing device having a stand-alone application that includes the one or more modules described herein. It can further be appreciated that the diagnostic system can be implemented as a web-service that can be accessed through the network.

As can be appreciated, the network 16 can be any type or a combination thereof of known networks including, but not limited to, a wide area network (WAN), a local area network (LAN), a global network (e.g., Internet), a virtual private network (VPN), and an Intranet. As can be further appreciated, the computing devices 10 can include, but are not limited to, a laptop, desktop computer, a workstation, a portable handheld device, or any combination thereof.

The computing device 12 includes a processor (not shown) and one or more storage devices (not shown). The processor can be any custom made or commercially available processor, a central processing unit, an auxiliary processor among several processors associated with the computing device, a semiconductor based micro-processor, a macro-processor, or generally any device configured for carrying out the methods and/or functions described herein. In one embodiment, the processor comprises a combination of hardware and/or software/firmware with a computer program that, when loaded and executed, permits the processor to operate such that it carries out the methods described herein. The one or more data storage devices can be at least one of the random access memory, read only memory, a cash, a stack, or the like which temporarily or permanently store data.

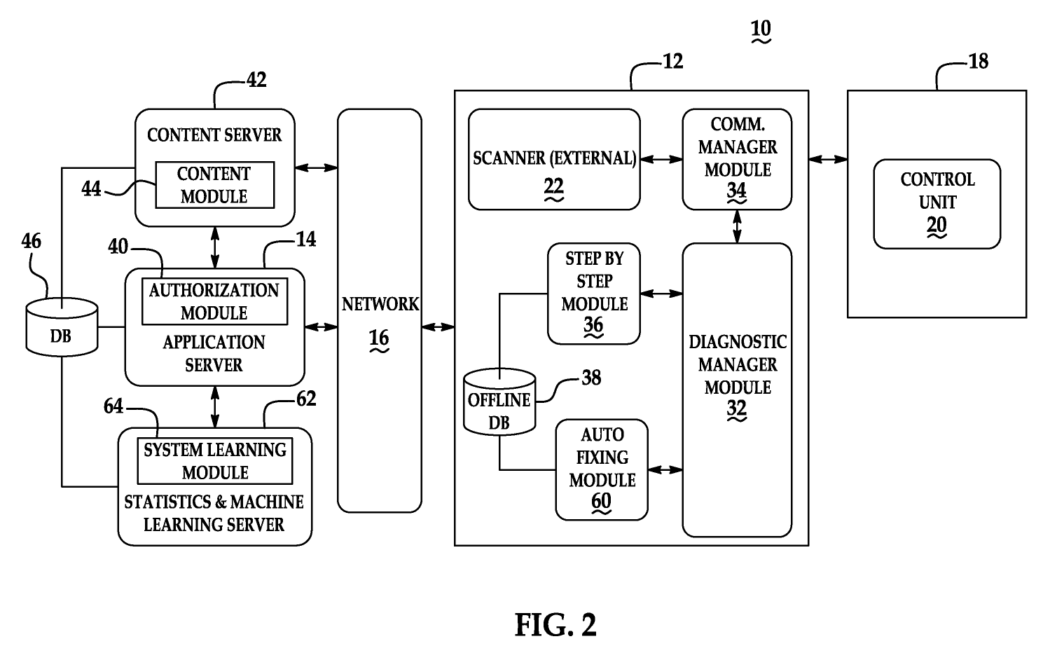

FIG. 2 illustrates a schematic of the diagnostic system 10 in more detail in accordance with one exemplary embodiment. The diagnostic system 10 includes computing device 12 in signal communication with the application server 14 via the network 16. The computing device 12 is selectively coupled to a system 18 and configured to facilitate a user in diagnosing the same. Specifically, the computing device 12 is selectively coupled to a control unit 20 of the system 18, which for example, is a vehicle in accordance with one embodiment. Of course, the system 18 can be any type of electronic system/device or appliance in accordance with other exemplary embodiments. For ease of discussion, exemplary embodiments will be discussed in the context of a vehicle.

In one embodiment, the computing device 12 includes a scanner 22 selectively coupled to the control unit 20 via an OBDII connector or a diagnostic socket/interface 24 of the vehicle utilizing a suitable connector cable 26 as shown in FIG. 3. The computing device 12 is configured to communicate to the control unit 20 over a CAN BUS protocol in accordance with one embodiment. Of course, other standard vehicle protocols or standard electronic buss' can be used and should not be limited to the example described herein. The control unit 20 is configured to transmit one or more signals containing vehicle status and diagnostic data over the CAN BUS protocol to the computing device 12. In one embodiment, the signals include diagnostic data configured to identify one or more diagnostic trouble codes (DTCs) or system faults that indicate a specific problem or issue with the vehicle 18. The signal can also include one or more electronic faults/failures relating to one or more electronic components associated with the vehicle. For example, the signal can include one or more faults including any component assembly and/or disassembly.

In accordance with one embodiment, the computing device 12 is associated with a display device 28 and one or more input devices 30 that enable bidirectional communication between the user and the computing device 12 as shown in FIG. 3. In particular, the input devices 30 allow predetermined instructions to be communicated interactively with the user in a step-by-step manner. The input devices 30 enable the computing device 12 to receive user inputs as the computing device 12 is communicating guided instructions to the user. The input devices 30 also allow the user to enter vehicle information (e.g., model, make year, components origin etc.), which can be used for diagnosing the vehicle and generating repair statistics. As can be appreciated, the input devices 30 may include, but are not limited to, a mouse, a keyboard, a microphone, and a touchpad. The display device 28 can be an integral part or a separate component of the computing device 12 depending on the application.

In accordance with one exemplary embodiment, the computing device 12 is configured to support a diagnostic manager module 32 that operably manages and analyzes vehicle data. The diagnostic manager module 32 manages the process of interactively communicating a set of predetermined instructions to the user in a step-by-step manner through a series of visuals. In one embodiment, the diagnostic manager module 32 is in communication with a command manager module 34, which is communicatively coupled to the scanner 22 and is configured to process and condition the signals received by the scanner 22 into a suitable format understood by the diagnostic manager module 32.

In one embodiment, the diagnostic manager module 32 is configured to access a set of predetermined instructions from a step-by-step module 36, which is communicatively coupled to an offline database 38 containing sets of predetermined instructions that assist the user in correcting one or more vehicle faults. In accordance with one embodiment, the step-by-step module 36 processes a request from the diagnostic manager module 32 and selects a set of predetermined instructions from the offline database 38 based on the request and the signals detected by the scanner 22. In another embodiment, the diagnostic manager module 32 accesses or downloads a set of predetermined instructions from the application server 14 via the network 16, which can provide a high rate of data throughput.

In accordance with one embodiment, the diagnostic manager module 32 accesses a set of predetermined instructions from the step-by-step module 36 when the computing device 12 is operating offline. This gives the user the ability to diagnose the vehicle in remote places where internet connection is weak or not accessible. In one non-limiting embodiment, the step-by-step module downloads these instructions into the offline database 38 from the application server 14 when the computing device 12 is operating online. In another non-limiting embodiment, the application server 14 directly downloads instructions into the offline database 38 when the computing device 12 is operating online. The offline database 38 makes sets of predetermined instructions available to the diagnostic manager module 32 when the computing device is offline. As such, the sets of predetermined instructions stored in the offline database 38 can be updated when the computing device 12 is back to operating online. In other words, additional sets of predetermined instructions can be stored in database 38, sets of predetermined instructions can be removed from database 38 and/or sets of predetermined instructions can be modified in database 38 when connection to the application server 14 is established.

When the computing device 12 is operating online, one or more sets of predetermined instructions can be accessed directly or indirectly from the application server 14 via network 16. The application server 14 can be any conventional application server 14 configured to support an authorization module 40 that operably authenticates and manages as well as provides online access to one or more servers and/or databases. In one embodiment, the application server 14 is communicatively coupled to a content server 42 configured to support a content-based module 44 that operably supports the addition, subtraction, modification, and generation of articles or documents (e.g., XML documents) within a network database 46 associated with the server. The content server 42 can be any conventional content server that is configured to organize and manage content within the network database 46. Optionally, the content server 42 can serve as a dedicated database, eliminating the need for the network database 46. In one embodiment, sets of predetermined instructions are stored within the network database 46 and can be optimized and updated continuously or periodically.

In accordance with one exemplary embodiment, the sets of predetermined instructions each comprise of a sequence of diagnostic steps that guides the user to a conclusion to correct one or more vehicle faults. In other words, each set of predetermined instructions is in the form of guided diagnostics that assists the user in reaching a conclusion to one or more vehicles faults reported by the control unit. In one embodiment, the sequences of diagnostic steps are each in the form of a flowchart. Each step comprise of one or more questions, statements, commands or otherwise. For example, a step may call for the user to locate a particular component of the vehicle and perform one or more tasks on the component. In another example, a step may call for the user to determine the status of one or more components of the vehicle. These sets of predetermined instructions being communicated to the user in flowchart form through visuals can improve the proficiency of the user, reduce unnecessary components replacement and shorten the time in diagnosing vehicle faults/failures.

In accordance with one exemplary embodiment, the diagnostic manager module 32 is configured to access a set of predetermined instructions from either the step-by-step module (offline) or the authorization module 34 (online) based on the signal(s) generated from the control unit 20 and/or user inputs. In operation, the diagnostic manager module 32 receives inputs from the user and/or receives signals from the control unit 20 of the vehicle. Then, the diagnostic manager module 32 processes the signals and/or user inputs to select a set of predetermined instructions that assists the user in locating and correcting one or more system faults. Next, the diagnostic manager module 32 accesses the set of predetermined instructions from the step-by-step module 36 or the authorization module 40 depending on the application. The diagnostic manager module 32 communicates the selected set of predetermined instructions interactively with the user in a step-by-step manner through a series of visuals at display device 28.

In accordance with one embodiment, the set of predetermined instructions are communicated interactively with the user by generating a plurality of audio signals, which can be heard by the user through one or more speakers (not shown) on the computing device or attached therewith. This allows the computing device 12 to communicate instructions to the user through visuals and sound. Optionally, the diagnosis process described herein includes interactive conversations between the user and a virtual support application operator, who can be accessed through the network 16 through conventional techniques.

In accordance with one exemplary embodiment, the series of visuals comprise video clips, streaming video, still images or a combination thereof For example, the diagnostic manager module 32 is configured to generate a schematic of the vehicle components or a flow diagram of instructions to assist the user in correcting vehicle faults/failures. In one embodiment, the series of visuals comprise three-dimensional (3D) animations. The diagnostic manager module 32 is configured to load and run the series of visuals at a high-rate with little or no interruptions. In one non-limiting embodiment, the diagnostic manager module 32 can load the series of visuals between 0.5-3 seconds. Of course, the diagnostic manager module 32 can have a load-rate of varying speeds and should not be limited to the example set forth herein.

In accordance with one embodiment, the diagnostic manager module 32 manages the sequence of diagnostic steps by iteratively receiving user inputs that indicate the passing or failing of each step in the sequence of diagnostic steps, which will now be described by way of example. For example, the diagnostic manager module 32 communicates a first diagnostic step of a sequence of diagnostic steps. Then, the diagnostic manager module 32 receives a user input that indicates the passing or failing of the first diagnostic step. This can be accomplished using input devices 28 as described above in accordance with one exemplary embodiment. Next, the diagnostic manager module 32 communicates a second diagnostic step of the sequence of diagnostic steps based on the user input directed to the first diagnostic step. This process continues until a conclusion has been reached.

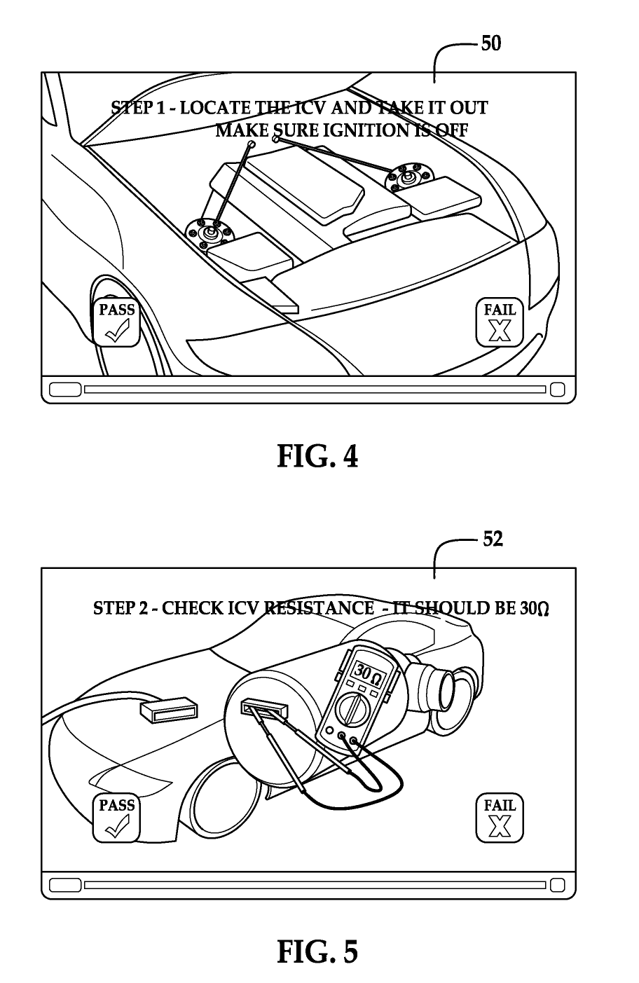

Now referring to FIGS. 4-5, exemplary screen shots are shown to better illustrate how the set of predetermined instructions are communicated interactively with the user in a step-by-step manner using a series of visuals as described above. Using the same example above, the first diagnostic step can be communicated to the user through an exemplary visual as illustrated in screen shot 50, which includes a 3D animation of the vehicle along with an instructive step. The second diagnostic step can be communicated to the user through another exemplary visual as illustrated in screen shot 52.

Referring back to FIG. 2, the computing device 12 is configured to support an auto-fixing module 60 that operably receives and analyzes diagnostic data to select one or more predetermined repair orders for correcting one or more electronic or system faults. In one embodiment, the auto-fixing module 60 is communicatively coupled to the diagnostic manager module 32 and is configured to provide predetermined repair orders to the diagnostic manager module 32 by request. The predetermined repair orders enable the control unit 20 to automatically tune or fix one or more electronic faults in the vehicle based on the diagnostic data. The predetermined repair orders are stored in the offline database 38 along with the sets of predetermined instructions and can be accessed by auto-fixing module 60 in accordance with one embodiment. In another embodiment, the predetermined repair orders are stored in another database (not shown) separate from the sets of predetermined instructions. In yet another embodiment, the predetermined repair orders are stored in network database 46 and can be accessed and downloaded from the application server 14 via the network 16 in a similar fashion to the sets of predetermined instructions as described above. The predetermined repair orders provided by the auto-fixing module 60 are sent to the control unit 20 over the CAN BUS protocol utilizing the scanner 22. The diagnostic manager module 32 is configured to automatically verify that such correction to the electronic faults has been made by receiving status or feedback information from the control unit 20. This automatic fixing process can eliminate the need for any hands-on work from the user, which can be cost-effective.

In accordance with one embodiment, the application server 14 is communicatively coupled to a statistics and machine learning server 62 configured to support a system learning module 64 that operably analyzes and collects various types of system information. The types of information may include, but are not limited to, vehicle information (e.g., model, make year, components origin), repair information/history (e.g., malfunctions and used repair procedures), system behavior, geographic information (e.g., climate, roads and driving conditions) and user behavior, which can be derived from one or more factors, such as, for example, user inputs. For example, the machine learning module 64 can collect information as to how the user corrected one or more faults in the vehicle by logging the user input to each diagnostic step. The system learning module 64 is configured to locate failure points and propose new repair or maintenance procedures to bypass the failures based on the aggregated information. This creates valuable information for car manufacturers, dealers, technicians or otherwise, who can access the application server directly or through one or more dedicated servers.

In accordance with one exemplary embodiment, the system learning module 64 is also configured to identify multiple faults and determine whether in fact a multiple fault situation or a single fault with projection to other components situation has occurred. For example, the breakdown of a single power supply can project its faults to multiple sensors that require power from the supply. The system learning module 64 is also configured to identify systematic failures while operating online. When the system identifies a systematic failure in one vehicle component, it may request for the scanning of similar components that might be at the same risk and provide suggestions to review and repair the components in a similar manner as the vehicle component originally identified.

In accordance with one exemplary embodiment, the system learning module 64 is configured to automatically optimize the process(s) or propose methods for optimizing the process(s) in correcting the one or more faults utilizing a neural network module (not shown), which can be any conventional artificial intelligent network software application that uses one or more Bayesian network equations and their statistic tables and/or algorithms that are based generally on the concept of self-learning. The system learning module 64 is also configured to propose or create new repair instructions based on the aggregated information. The accuracy of these Bayesian network equations can be refined by automatically updating statistic table parameters utilizing conventional artificial intelligent networks. As such, the sets of predetermined instructions and repair orders stored in the network database 46 can be optimized or updated accordingly. In effect, the instructions and orders stored in database 38 can also be optimized or updated. It can be appreciated that the system learning module can modify itself or develop new algorithms while the system learning module continues to collect the various types of information as described above utilizing conventional artificial intelligent networks/systems.

In one example, in an event of a multi-fault sequence (e.g., three faults detected at the same time) the system learning module 64 can identify whether a single source, which can project to other components, has caused these faults. Using a real example, a malfunction that can be caused by a common five-volt source can generate multiple faults to several components, such as an airflow sensor, throttle position sensor, air temperature and so forth. This will generate more than three faults in the scanner and the vehicle will behave negatively since there is no control from those sensors resulting in miss firings, no throttle, knocking and so on. Normally, the user will then need to follow one or more sets of predetermined sequences and may even need to replace all those sensors when all that needs to be done is to correct the problem with the five-volt supply. The system learning module 64 described herein can remedy this problem by identifying whether the multiple faults are caused by a single source or multiple sources and optimizing the diagnostic procedures accordingly. In another example, when users worldwide are acting in a certain way, the system learning module can identify whether the results are improved and can change the original sequence to reach better results of the diagnostic procedure. Using a real example, a fault will occur when the original sequence indicates replacing a step motor lever when in the fact the real problem stems from a chip stuck in the lever. The system learning module described herein can track when a user identifies another solution (e.g., removing the chip stuck in the lever) and add it to the diagnostic sequence accordingly.

In accordance with one exemplary embodiment, the system learning module 64 is configured to propose optimizations that simplify the sets of predetermined instructions. For example, the system learning module 64 can propose a method of simplifying a set of instructions having five diagnostic steps into a set of instructions with less than five diagnostic steps. Other ways of optimizing the diagnostic process can be used and should not be limited to the example set forth herein.

In accordance with one exemplary embodiment, the system learning module 64 is configured to generate various reports, such as, repair statistics reports and repeating failure statistics reports for manufacturers, dealers, technicians, or various user types. This is accomplished by collecting vehicle information, repair information (e.g., repair history) and user behavior from one or more computing devices. This can also be accomplished through the implementation of conventional statistical and machine learning approaches. This process can enhance the solution to monitor technician and repair center quality.

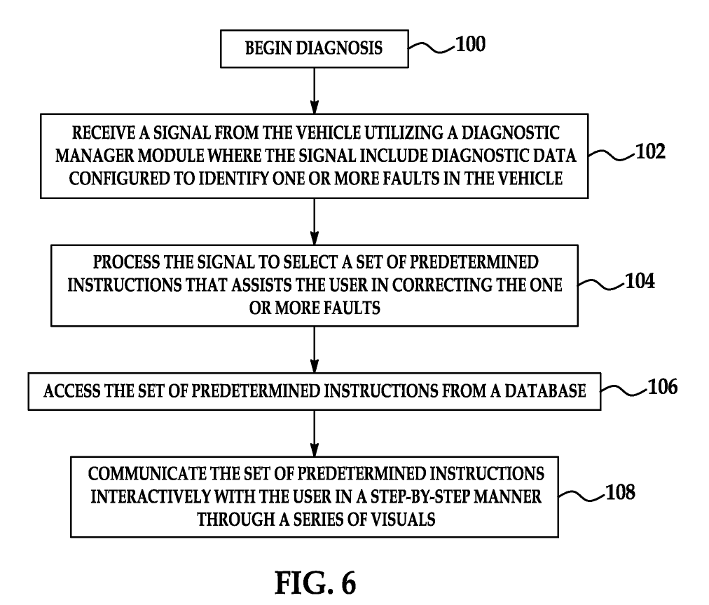

Now referring to FIG. 6, a method for facilitating a user in diagnosing a vehicle in accordance with one exemplary embodiment will now be discussed.

At operational block 100, begin diagnosis.

At operational block 102, receive a signal from the vehicle utilizing a diagnostic manager module where the signal includes diagnostic data configured to identify one or more faults in the vehicle.

At operational block 104, process the signal to select a set of predetermined instructions that assist the user in correcting the one or more faults.

At operational block 106, access the set of predetermined instructions from a database. In accordance with one embodiment, the set of predetermined instructions are accessed from an offline database 38. In another embodiment, the set of predetermined instructions are accessed from a network database 46 utilizing network 16.

At operational block 108, communicate the set of predetermined instructions interactively with the user in a step-by-step manner through a series of visuals. Optionally, the set of predetermined instructions are communicated interactively with the user by generating a plurality of audio signals.

The exemplary embodiments of the diagnostic system provide user generated 3D content and offer the monitoring of component replacement from users world-wide. This network-based system assists technicians in troubleshooting and repairing vehicle faults in an efficient and cost-effective manner. This network based system also enables information to easily transfer to claims divisions or the like for automatic review and verification.

It is contemplated that the exemplary embodiments of the diagnostic system described herein can provide a search engine that will assist users in searching for answers or diagnostic solutions for a particular system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A method for facilitating a user in diagnosing a vehicle, the method comprising:
receiving a signal from the vehicle utilizing a diagnostic manager module, the signal having diagnostic data configured to identify one or more faults in the vehicle;
processing the signal to select a set of predetermined instructions that assists the user in correcting the one or more faults;
accessing the set of predetermined instructions from a database; and
communicating the set of predetermined instructions interactively with the user in a step-by-step manner through a series of visuals.

2. The method of claim 1, including communicating interactively with the user the set of predetermined instructions as a sequence of diagnostic steps that guides the user to a conclusion to correct the one or more faults.

3. The method of claim 2, wherein the sequence of diagnostic steps is in the form of a flowchart.

4. The method of claim 2, including managing the sequence of diagnostic steps by iteratively receiving user inputs that indicate the passing or failing of each step in the sequence of diagnostic steps.

5. The method of claim 1, including communicating the set of predetermined instructions interactively with the user by generating a plurality of audio signals.

6. The method of claim 1, wherein the series of visuals comprise three-dimensional animations.

7. The method of claim 1, wherein the one or more faults comprises of an electronic fault.

8. The method of claim 7, including correcting the electronic fault in response to the diagnostic manager module receiving and processing the signal.

9. The method of claim 8, wherein the electronic fault is corrected automatically by one or more predetermined repair orders.

10. The method of claim 8, including verifying the correction of the electronic fault.

11. The method of claim 1, wherein the series of visuals comprise of video clips, streaming video, still images or a combination thereof.

12. A diagnostic system for facilitating a user in diagnosing a system, comprising:
a processor configured to receive a signal from the system, the signal having diagnostic data configured to identify one or more faults in the vehicle,
an application server in communication with the processor via a network, the processor configured to process the signal and receive a set of predetermined instructions from the application server, the set of predetermined instructions configured to assist the user in correcting the one or more faults; and
a display device coupled to the processor, the display device configured to communicate the set of predetermined instructions interactively with the user in a step-by-step manner through a series of visuals.

13. The diagnostic system of claim 12, wherein the set of predetermined instructions includes a sequence of diagnostic steps that guides the user to a conclusion to correct the one or more faults, the sequence of diagnostic steps being communicated interactively with the user.

14. The diagnostic system of claim 13, wherein the sequence of diagnostic steps is in the form of a flowchart.

15. The diagnostic system of claim 13, wherein the processor manages the sequence of diagnostic steps by iteratively receiving user inputs that indicate the passing or failing of each step in the sequence of diagnostic steps.

16. The diagnostic system of claim 12, wherein the set of predetermined instructions is further communicated interactively with the user by generating a plurality of audio signals.

17. The diagnostic system of claim 12, wherein the series of visuals comprise three-dimensional animations.

18. A method for facilitating a user in diagnosing and repairing a system, comprising:
receiving a signal from the system utilizing a diagnostic manager module, the signal having diagnostic data configured to identify one or more faults in the system;
processing the signal to obtain a set of predetermined instructions that assists the user in correcting the one or more faults; and
communicating the set of predetermined instructions interactively with the user in a step-by-step manner through a series of visuals.
